(19) United States
(12) Patent Application Publication
(10) Pub. No.: US 2011/0185406 A1
(43) Pub. Date: Jul. 28, 2011

(54) Systems and Methods to Authenticate Users

(75) Inventors: Ron Hirson, San Francisco, CA (US); David Yoo, San Mateo, CA (US)

(73) Assignee: BOKU, INC., San Francisco, CA (US)

(21) Appl. No.: 13/012,589

(22) Filed: Jan. 24, 2011

Related U.S. Application Data
(60) Provisional application No. 61/298,461, filed on Jan. 26, 2010.

(51) Int. Cl. H04L 9/32

(52) U.S. Cl. 726/6; 726/2; 726/5

(57) ABSTRACT

Systems and methods are provided to facilitate online transactions via mobile communications. In one aspect, a system includes a data storage facility to store account information with a phone number of the user and an interchange coupled with the data storage facility. The interchange includes a common format processor and a plurality of converters to interface with a plurality of different controllers of mobile communications. The converters are configured to communicate with the controllers in different formats; and the converters are configured to communicate with the common format processor in a common format to facilitate authentication of the user to sign in the account.

### CROSS-REFERENCE TO RELATED APPLICATIONS

The present application claims the benefit of Prov. U.S. patent application Ser. No. 61/298,461, filed Jan. 26, 2010 and entitled “Systems and Methods to Authenticate Users,” the disclosure of which is hereby incorporated herein by reference.

### FIELD OF THE TECHNOLOGY

At least some embodiments of the disclosure relate to mobile communications in general and, more particularly but not limited to, mobile communications to facilitate online transactions.

### BACKGROUND

Short Message Service (SMS) is a communications protocol that allows the interchange of short text messages between mobile telephone devices. SMS messages are typically sent via a Short Message Service Center (SMSC) of a mobile carrier, which uses a store-and-forward mechanism to deliver the messages. When a mobile telephone is not reachable immediately for the delivery of the message, the SMSC stores the message for later retry.

SMS messages can be sent via gateways. Some gateways function as aggregators. An aggregator typically does not have the capacity to deliver the messages directly to the mobile phones. An aggregator typically interfaces with and relies upon the SMSC of a mobile carrier to deliver SMS messages.

Some gateways function as providers that are capable of sending text messages to mobile devices directly, without going through the SMSC of other mobile operators.

Text messaging between mobile telephones can also be performed using other protocols, such as SkyMail and Short Mail in Japan.

Some mobile carriers provide email gateway services to allow text messages to be sent to mobile phones via email. For example, a non-subscriber of the mobile carrier may send a message to an email address associated with a mobile phone of a subscriber of the mobile carrier to have the message delivered to the mobile phone via text messaging.

Emails can also be sent to mobile telephone devices via standard mail protocols, such as Simple Mail Transfer Protocol (SMTP) over Internet Protocol Suite (commonly TCP/IP, named from two of the protocols: the Transmission Control Protocol (TCP) and the Internet Protocol (IP)).

Short messages may be used to provide premium services to mobile phones, such as news alerts, ring tones, etc. The premium content providers may send the messages to the SMSC of the mobile operator using a TCP/IP protocol, such as Short Message Peer-to-peer Protocol (SMPP) or Hypertext Transfer Protocol, for delivery to a mobile phone; and the mobile phone is billed by the mobile operator for the cost of receiving the premium content.

Premium services may also be delivered via text messages initiated from the mobile phone. For example, a televoting service provider may obtain a short code to receive text messages from mobile phones; and when the user sends a text message to the short code, the mobile carrier routes the message to the televoting service provider and charges the user a fee, a portion of which is collected for the televoting service provider.

### SUMMARY OF THE DESCRIPTION

Systems and methods are provided to facilitate online transactions via mobile communications. Some embodiments are summarized in this section.

In one aspect, a system includes a data storage facility to store account information with a mobile phone number of a user and an interchange coupled with the data storage facility. The interchange includes a common format processor and a plurality of converters to interface with a plurality of different controllers of mobile communications. The converters are configured to communicate with the controllers in different formats; and the converters are configured to communicate with the common format processor in a common format.

In one embodiment, the common format processor is configured to receive a request from a host to authenticate the user to sign in an account on the host. The common format processor is further configured to instruct a first controller of the controllers, via a first converter of the converters, to communicate with a mobile phone of the user at the mobile phone number to confirm an identity of the user. If the identity of the user is confirmed via communicating with the mobile phone, the common format processor is configured to provide the host with the account information to allow the user to sign in the account.

In another aspect, a method includes: receiving, at a computer, a request from a host to authenticate a user to sign in an account on the host; communicating, by the computer, with a mobile phone of the user at a phone number specified by the user to confirm an identity of the user; and if the identity of the user is confirmed via the communicating with the mobile phone, providing, by the computer, information to the host to allow the user to sign in the account.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIG. 1 shows a system to facilitate online transactions according to one embodiment.

FIG. 2 shows an interchange to route messages according to one embodiment.

FIG. 3 shows a message processor according to one embodiment.

FIG. 4 shows a method to facilitate an online transaction using an interchange according to one embodiment.

FIG. 5 illustrates a user interface to associate an account with a telephone number according to one embodiment.

FIG. 6 illustrates another user interface to associate an account with a telephone number according to one embodiment.

FIG. 7 illustrates a user interface to initiate a payment transaction according to one embodiment.

FIG. 8 illustrates a user interface to initiate a payment request according to one embodiment.

FIG. 9 illustrates a user interface to confirm a payment request according to one embodiment.

FIG. 10 illustrates a user interface to confirm the completion of a payment transaction according to one embodiment.

FIG. 11 illustrates a way to redirect a payment confirmation according to one embodiment.

FIG. 12 illustrates a user interface to receive payment options according to one embodiment.

FIG. 13 shows a method to process an online payment according to one embodiment.

FIG. 14 shows another method to facilitate a payment transaction according to one embodiment.

FIG. 15 illustrates a user interface to confirm a transaction according to one embodiment.

FIG. 16 illustrates a mobile phone configured to confirm transactions according to one embodiment.

FIGS. 17-19 illustrate methods to confirm transactions according to one embodiment.

FIG. 20 shows a user interface to sign a user in according to one embodiment.

FIG. 21 shows a user interface to obtain a phone number to sign a user in according to one embodiment.

FIG. 22 shows a mobile user interface to confirm the identity of a user according to one embodiment.

FIG. 23 shows another user interface to sign a user in according to one embodiment.

FIG. 24 shows a system to sign a user in according to one embodiment.

FIG. 25 shows a method to sign a user in according to one embodiment.

FIG. 26 shows a data processing system, which can be used in various embodiments.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In one embodiment, an interchange is used to interface with a plurality of different controllers of mobile communications, such as SMS messages. The interchange can be used to associate account information with phone numbers to facilitate electronic payments via mobile devices, such as cellular phones. The interchange is configured to communicate with the mobile phones through the different controllers to provide security and convenience for online transactions.

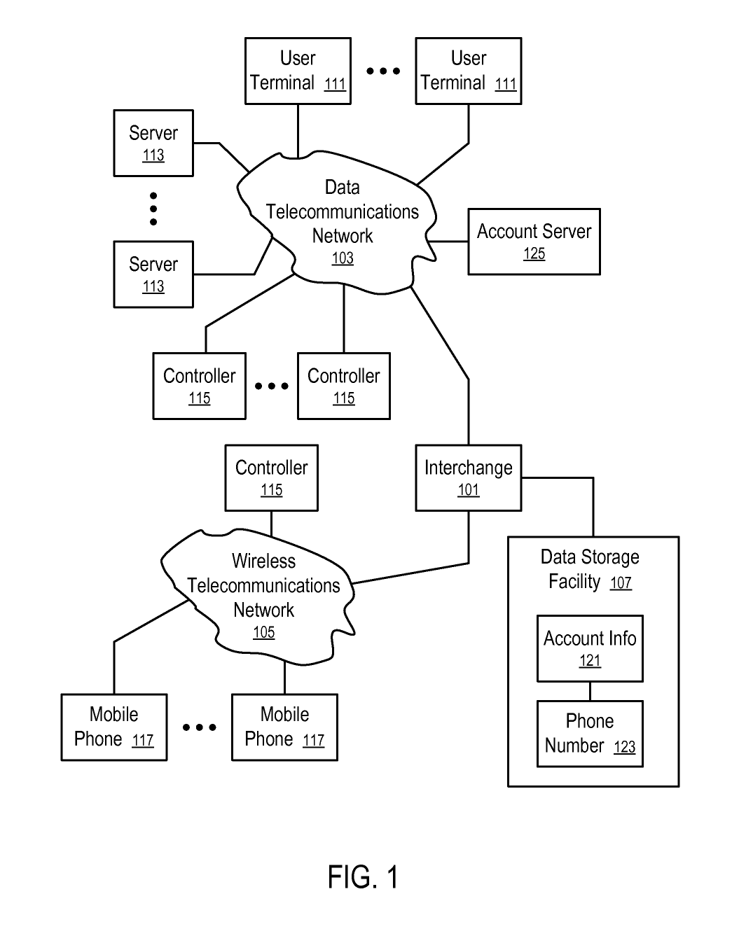

FIG. 1 shows a system to facilitate online transactions according to one embodiment. In FIG. 1, an interchange (101) is provided to interface with a plurality of different controllers (115) for communications with the mobile phones (117) over the wireless telecommunications network (105).

In FIG. 1, a data storage facility (107) stores user account information (121) and the corresponding phone numbers (123) of the mobile phones (117). The interchange (101) is coupled with the data storage facility (107) to communicate with the mobile phones (117) at the corresponding phone numbers (123) to confirm operations that are performed using the account information (121). Since the account information (121) is secured by the interchange (101), the account information (121) can be used to pay for products and services offered by the servers (113) of various merchants, without being revealed to the merchants.

In one embodiment, the server (113) offers products and/or services adapted for a virtual world environment, such as an online game environment, a virtual reality environment, etc. The products may be virtual goods, which can be delivered via the transmission of data or information (without having to physically deliver an object to the user). For example, the virtual goods may be a song, a piece of music, a video clip, an article, a computer program, a decorative item for an avatar, a piece of virtual land in a virtual world, a virtual object in a virtual reality world, etc. For example, an online game environment hosted on a server (113) may sell services and products via points or virtual currency, which may be consumed by the user while engaging in a game session. For example, a virtual reality world hosted on a server (113) may have a virtual currency, which may be used by the residents of the virtual reality world to conduct virtual commerce within the virtual reality world (e.g., buy virtual lands, virtual stocks, virtual objects, services provided in the virtual reality world, etc). In other embodiments, the server (113) may also offer physical goods, such as books, compact discs, photo prints, postcards, etc.

In FIG. 1, the interchange (101) may communicate with different controllers (115) of mobile communications via different networks (e.g., 105 and 103) and/or protocols. The interchange (101) processes the requests in a common format and uses a set of converters for communications with the different controllers (115) respectively.

For example, the controllers (115) may be different aggregators, providers and/or SMSCs of different mobile carriers. Based on the phone numbers (123), the interchange (101) interfaces with the corresponding controllers (115) to communicate with the mobile phones (117) via text messaging to confirm the operations related to the corresponding account information (121), such as bank accounts, credit card numbers, charge card numbers, etc.

In FIG. 1, the user terminals (111) may use a unified interface to send requests to the interchange (101). For example, a website of the interchange (101) may be used to receive the account information (121) from the web browsers running in the user terminals (111). The user terminals (111) are typically different from the mobile phones (117). However, in some embodiments, users may use the mobile phone (117) to access the web and submit the account information (121). Alternatively, the users may use the mobile phone (117) to submit the account information (121) to the interchange (101) via text messaging, email, instant messaging, etc.

The use of the mobile phones (117) in the confirmation of activities that involve the account information (121) increases the security of the transaction, since the mobile phones (117) are typically secured in the possession of the users.

Further, in one embodiment, the interchange (101) may use the phone bills of the mobile phones (117) to pay for purchases, in order to use the account information (121) to pay for the phone bills, and/or to deposit funds into the accounts identified by the account information (121) by charging on the phone bills of the corresponding mobile phones (117). In some embodiments, the accounts identified by the account information (121) are hosted on the data storage facility (107). In other embodiments, the accounts are hosted on the account servers (125) of financial institutions, such as banks, credit unions, credit card companies, etc.

In one embodiment, once the account information (121) is associated with the mobile phones (117) via their phone numbers (123) stored in the data storage facility (107), the users may use the user terminals (111) to access online servers (113) of various merchants or service providers to make purchases. From the user terminals (111), the users can use the accounts identified by the account information (121) to make the payment for the purchases, without revealing their account information (121) to the operators of the servers (113).

In one embodiment, the mobile phones (117) are used by the corresponding users to make payments and/or manage funds, such as for making purchases in various websites hosted on the servers (113) of merchants and service providers and/or for transferring funds to or from an account identified by the account information (121), such as phone bills of land-line telephone services, credit card accounts, debit card accounts, bank accounts, etc., or an account hosted on the data storage facility (107) or telecommunication accounts of the mobile phones (117) with telecommunication carriers. The mobile phones (117) are used to confirm and/or approve the transactions associated with the account identified by the account information (121) (or other accounts). The interchange (101) interfaces the mobile phones (117) and the servers (113) to confirm and/or approve transactions and to operate on the account identified by the account information (121) (and/or other accounts associated with the phone number (123)).

For example, the user terminal (111) may provide the phone numbers (123) to the servers (113) to allow the servers (113) to charge the account identified by the account information (121) associated with the phone number (123). The interchange (101) sends a message to the mobile phone (117) via the phone number (123) to confirm the payment request. Once the payment is confirmed or approved via the corresponding mobile phone (117), the interchange (101) charges the account identified by the account information (121) (e.g., by communicating with the account server (125) on which the corresponding accounts are hosted) and pays the server (113) on behalf of the user, using the funds obtained from the corresponding account identified by the account information (121).

In one embodiment, the user terminal (111) may not even provide the phone number (123) to the server (113) to process the payment. The server (113) may redirect a payment request to the interchange (101), which then prompts the user terminal (111) to provide the phone number (123) to the website of the interchange (101) to continue the payment process.

For example, the server (113) may redirect the payment request to the website of the interchange (101) with a reference indicating the purchase made via the user terminal (111). The interchange (101) can use the reference to subsequently complete the payment with the server (113) for the purchase, after receiving the phone number (123) directly from the user terminal (111) to confirm the payment via the mobile phone (117).

In some embodiments, instead of directly providing the phone number (123) to identify the account information (121), the user may provide other information to identify the phone number (123), such as an account identifier of the user assigned to the user for obtaining the services of the interchange (101).

In one embodiment, the account information (121) is pre-associated with the phone number (123) prior to the payment request. The account information (121) may be submitted to the interchange (101) via the user terminal (111) or the mobile phone (117) via a secure connection.

Alternatively, the user may supply the account information (121) to the interchange (101) at the time the payment request is submitted from the user terminal (111) to the interchange (101). Alternatively, the user may supply the account information (121) to the interchange (101) at the time the user responds to the confirmation message for the payment request.

In some embodiments, the user may supply the account information (121) after a transaction using funds collected via the telecommunication carrier of the mobile phone (117) at the phone number (123). For example, after the transaction, the interchange (101) may send an invitation message, such as a text message to the mobile phone (117) at the phone number (123), to the user to invite the user to register with the interchange (101) and provide the account information (121). The user may register with the interchange (101) via the mobile phone (117) (e.g., by a replying text message), or via a web page of the interchange (101) (e.g., using a link and/or a unique code provided in the invitation message).

After the user registers with the interchange (101) (e.g., via the mobile phone (117) and by providing the account information (121)), the user may create a customized personal identification number (PIN) or receive a PIN for enhanced security. Using the PIN, the user may use the account information (121) to complete an online transaction without having to confirm and/or approve a transaction using the mobile phone (117). In some embodiments, the PIN may be used to reduce unwanted messages to the mobile phone (117). For example, once the phone number (123) and the account information (121) are associated with a PIN, the interchange (101) may require the user of the user terminal (111) to provide the correct PIN to initiate the payment process. Thus, a spammer having only the phone number (123) (or a different user mistakenly using the phone number (123)) may not successfully use the user terminal (111) to request the interchange (101) to send confirmation messages to the mobile phone (117) protected by the PIN. In some embodiments, the interchange (101) may offer further incentives to the user for registering with the interchange (101), such as reduced fees, discounts, coupons, free products and services, etc.

In one embodiment, once the account information (121) is associated with the phone number (123) in the data storage facility (107), the user does not have to resubmit the account information (121) in subsequent payment requests.

By delegating the payment task to the interchange (101) and securing the account information (121) in the data storage facility (107), the system as shown in FIG. 1 can increase the security of using the account information (121) in an online environment.

In some embodiments, the interchange (101) can also fulfill the payment requests using the funds collected via the phone bill of the phone numbers (123). The interchange (101) can collect the funds via sending premium messages to the mobile phones (117) at the phone numbers (123), after receiving confirmation from the mobile phone (117).

For example, after the confirmation or approval message is received from the mobile phone (117), the interchange (101) performs operations to collect funds via the phone bill of the phone number (123). The interchange (101) may calculate the required premium messages to bill to the mobile phone (117). For example, mobile terminated premium SMS messages may have a predetermined set of prices for premium messages. The interchange (101) determines a combination of the premium messages that has a price closest to the amount required by the transaction, and sends this combination of premium messages to the mobile phone (117). For example, mobile originated premium SMS messages may also have a predetermined set of prices for premium messages. The interchange (101) can calculate the set of messages required for the transaction and transmit a text message to the mobile phone (117) of the user to instruct the user to send the required number of premium messages to provide the funds.

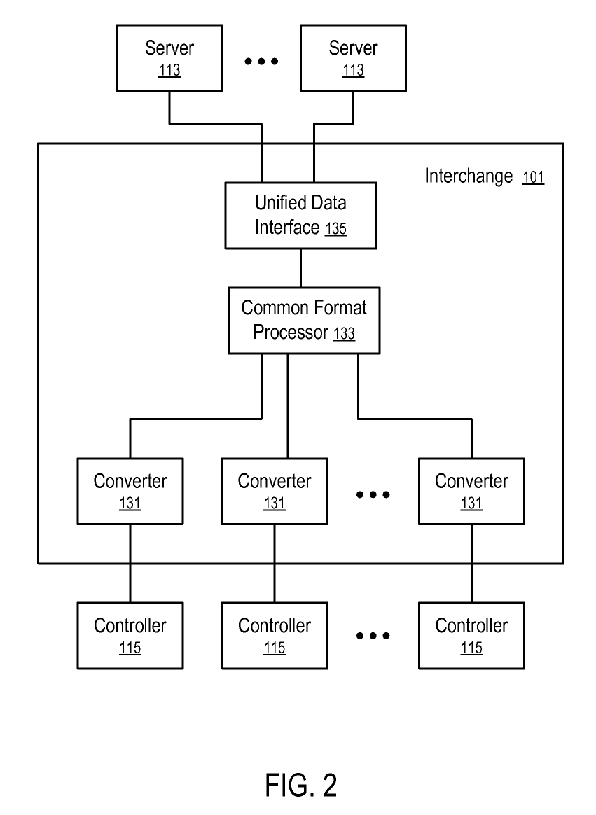

FIG. 2 shows an interchange to route messages according to one embodiment. In FIG. 2, the interchange (101) includes a unified data interface (135) for interaction with the servers (113). The servers (113) may redirect the payment requests to the interchange (101) to allow the interchange (101) to subsequently communicate with the user to process the payment request, including obtaining payment options and identifying user accounts (123), before returning to communicating with the server (113). Alternatively, the servers (113) may collect account related information (e.g., the phone number of the user) to request payment from the interchange (101).

In FIG. 2, the interchange (101) includes a common format processor (133), which processes various payment options in a common format. In one embodiment, the common format processor (133) can handle the payments via mobile terminated text message, mobile originated text message, operator bill, credit card, stored value account, and other online payment options. The common format processor (133) determines the actual amount that is to be billed to the user, based on the payment options (e.g., mobile terminated premium SMS, mobile originated premium SMS, operator billing, credit cards, etc.), and selects a converter (131) to communicate with a corresponding controller (115).

Different converters (131) are configured to communicate with corresponding controllers (115) in different languages and protocols. The converters (131) perform the translation between the common format used by the common format processor (133) and the corresponding formats used by the controllers (115).

The use of the common format processor (133) simplifies the structure of the interchange (101) and reduces the development effort required for the interchange (101) to interface with the increasing number of different controllers, such as SMSC, mobile providers, aggregators, gateways, etc.

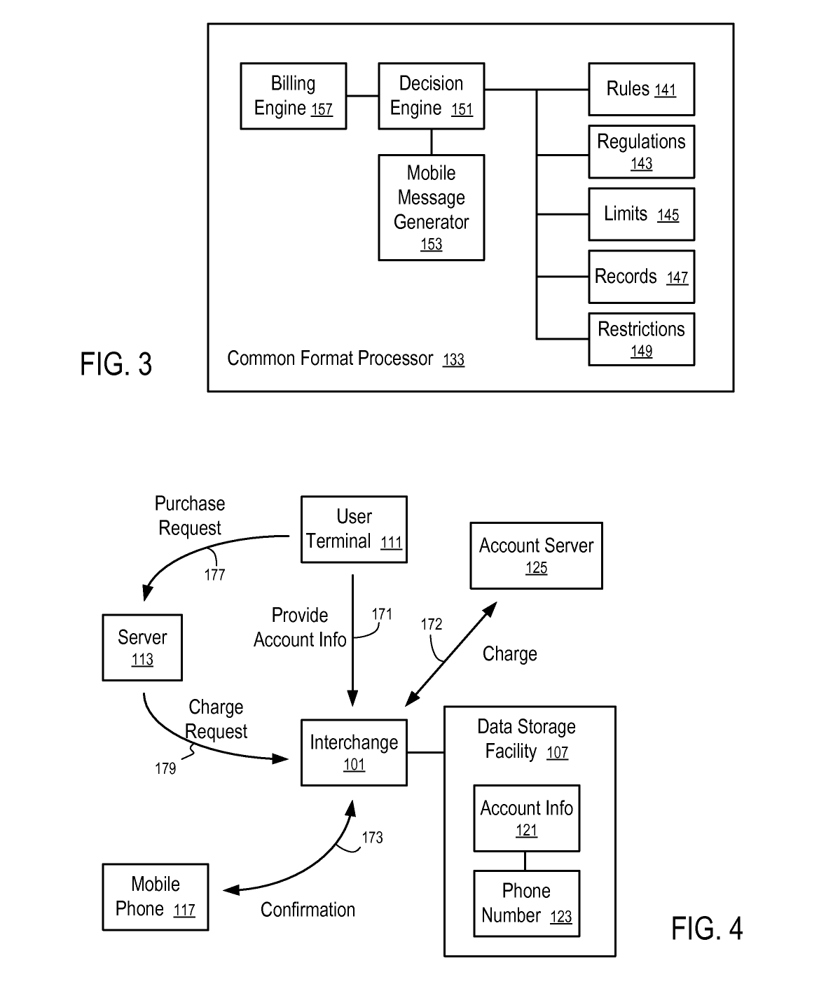

FIG. 3 shows a message processor according to one embodiment. In FIG. 3, the common format processor (133) includes a billing engine (157) that calculates the amount to be billed to the user, by adding or subtracting transaction costs for different billing methods, such as mobile terminated text message, mobile originated text message, operator billing, credit card, stored value account, and other online payment options.

In one premium message billing method, the interchange (101) sends mobile terminated premium SMS messages to the mobile phone (117) to bill the user, or requests the mobile phone (117) to send mobile originated premium SMS messages to a short code representing the interchange (101).

In one operator billing method, the interchange (101) directly sends a message to the mobile carrier of the mobile phone (117) to bill the amount on the phone bill of the mobile phone (117), without having to send a premium message to the mobile phone (117).

The common format processor (133) includes a decision engine (151) which decides how to generate a set of one or more messages to the mobile phone (117) based on a set of rules (141), regulations (143), limits (145), records (147) and restrictions (149).

For example, different countries have different regulations (143) governing the mobile communications with the mobile phones (117). For example, different mobile carriers have different rules (141) regarding premium messages. For example, past transaction records (147) can be used to monitor the transactions to discover suspected fraudulent activities. For example, parental limits (145) and merchant restrictions (149) can be imposed.

Based on results of the decision engine (151), the mobile message generator (153) generates one or more messages to communicate with the mobile phone (117) about the transaction (e.g., a request to collect funds via the phone bill of the user for a payment request, or for deposit into an account identified by the account information (121)). The converter (131) then interfaces with the corresponding controller (115) to transmit the messages to the mobile phones (117).

FIG. 4 shows a method to facilitate an online transaction using an interchange according to one embodiment. In FIG. 4, the user terminal (111) provides (171) account information (121) to the interchange (101) for association with the phone number (123). For example, the user may use a device running a web browser as the user terminal (111) to submit the account information (121) via a secure web connection. The user terminal (111) is typically different from the mobile phone (117). However, in some embodiments, the mobile phone (117) may also be used as the user terminal (111) to submit the account information (121) (e.g., via a wireless application protocol (WAP) application, or via a message sent via short message service (SMS) or multimedia message service (MMS), or via an email message or an instant message).

After the user provides the account information (121) to the interchange (101) for storage in the data storage facility (107), the user can send (177) a charge request to the server (113) of a merchant from the user terminal (111). The server (113) of the merchant can send or redirect (179) the charge request to the interchange (101). In response to the charge request, the interchange (101) sends (173) a confirmation message to the mobile phone (117). If the user sends (173) an approval, or an appropriate reply, to the confirmation message from the mobile phone (117), the interchange (101) communicates with the account server (125) to charge an account of the user identified by the account information (121), without revealing the account information (121) to the server (113). The interchange (101) pays the merchant on behalf of the user using the funds collected via charging the account of the user. For example, the interchange (101) may use its own bank account to pay the merchant operating the server (113). Thus, the financial information of the user is not revealed to the merchant.

Upon the completion of the payment process, the interchange (101) can notify the user via the mobile phone (117) and/or the user terminal (111).

In some embodiments, the server (113) of the merchant redirects the charge request to allow the user terminal (111) to communicate with the interchange (101) to continue the payment process; and the user terminal (111) may provide (171) the account information (121) directly to the interchange (101) after the charge request is redirected.

In alternative embodiments, the user may provide the account information (121) from the mobile phone (117) together with the approval of the charge request.

In one embodiment, the interchange (101) communicates with the mobile phone (117) for the confirmation of the charge request via SMS messages. Alternatively, the confirmation and approval messages can be sent (173) via emails, instant messages, voice message, live calls from operators, etc.

In some embodiments, the user of the mobile phone (117) may choose to fulfill the charge request via the phone bill, instead of charging the account identified by the account information (121). Thus, after the confirmation, the interchange (101) sends the premium messages to the mobile phone (117) to collect funds via the phone bill of the mobile phone (117). In other embodiments, the interchange (101) may send an instruction with the confirmation message to the mobile phone (117) to instruct the user to send mobile originated premium messages to the interchange (101) to collect the funds via the phone bill of the mobile phone (117).

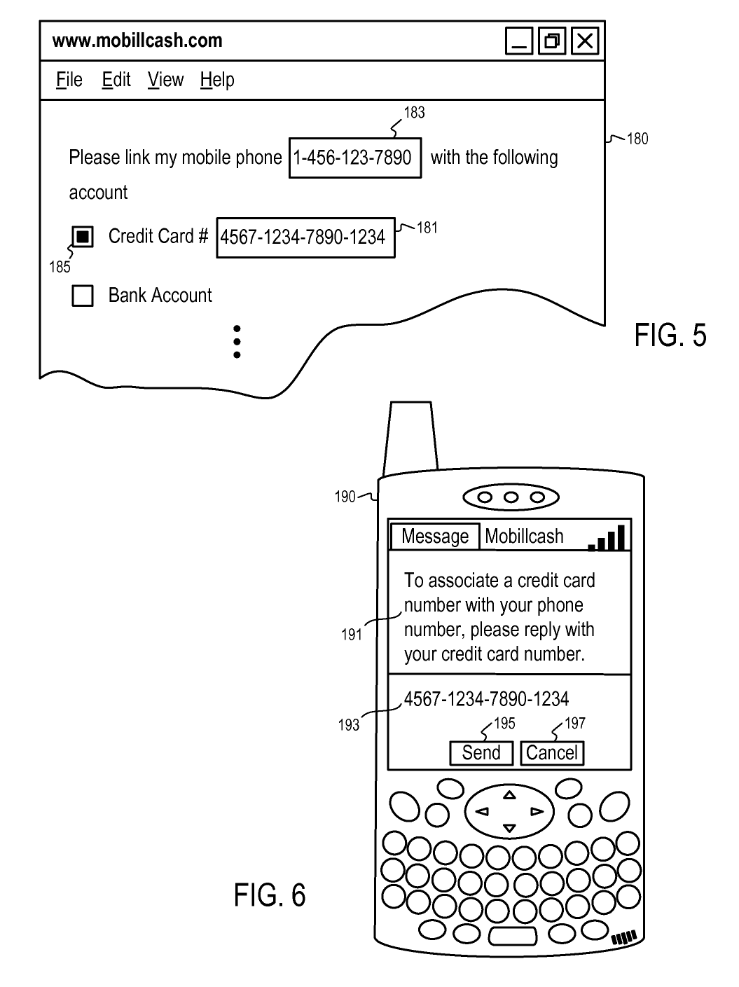

FIG. 5 illustrates a user interface to associate an account with a telephone number according to one embodiment. In FIG. 5, the user interface (180) includes a text field (183) that allows the user to specify the phone number (123) with which the account information (121) provided in the text field (181) is to be associated.

In FIG. 5, the user interface (180) further includes an option list, which allows the user to select various types of accounts, such as credit card accounts, bank accounts, charge card accounts, etc. In the example illustrated in FIG. 5, the checkbox (185) is selected to specify a credit card account.

In some embodiments, the user interface (180) may further present a text field (not shown in FIG. 5) to allow the user to specify an alias for the account information (121) supplied in the text input field (181). For enhanced security, the alias can be used for subsequent communications with the user without revealing the account information (121).

In FIG. 5, the user interface (180) may be presented via a web browser (or a custom application) to submit account information (121) in the text input field (181) from a user terminal (111) to the interchange (101). Alternatively, the account number can be submitted from the mobile phone (117) via a message sent via SMS, WAP, voice mail, or via an interactive voice response (IVR) system.

FIG. 6 illustrates another user interface to associate an account with a telephone number according to one embodiment. In FIG. 6, the user interface (190) is presented on the mobile phone (117) of the user. The user interface (190) presents a message (191) from the interchange (101) to the mobile phone (117) at the phone number (123). The message (191) prompts the user to submit the account information (121) by providing a reply message (193). The user may select the “send” button (195) to provide the account information (121) for association with the phone number (123) or select the “cancel” button (197) to ignore the prompt.

In one embodiment, the messages (191 and 193) are transmitted to the mobile phone (117) via a short message service (SMS). Alternatively, the messages can be transmitted to the mobile phone (117) via other protocols, such as multimedia message service (MMS), email, instant messaging, WAP, voice mail, voice messages via an interactive voice response (IVR) system, etc.

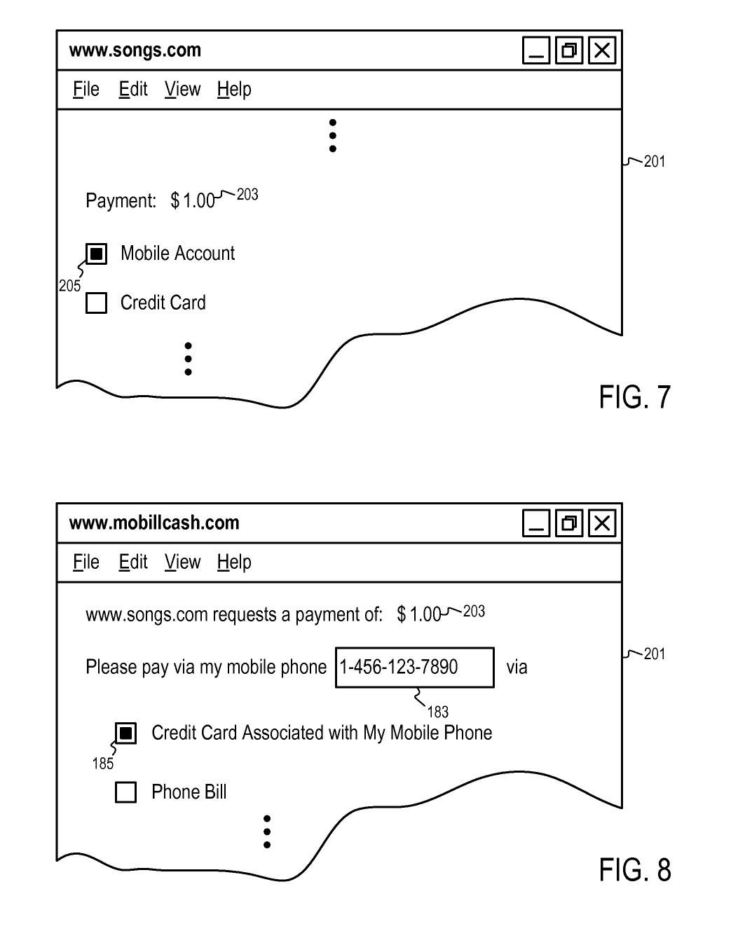

FIG. 7 illustrates a user interface to initiate a payment transaction according to one embodiment. In FIG. 7, the user interface (201) provides an option (205) to request the interchange (101) to process the payment for the amount (203) required to make a purchase from the server (113) of a merchant.

In one embodiment, after the user selects the payment option (205), the server (113) directs the request to the web server of the interchange (101), with a set of parameters to indicate the amount (203), the identity of the merchant, a reference to the purchase, etc. Thus, the user does not have to provide any personal information to the server (113) of the merchant to complete the payment process.

Alternatively, the user may provide the phone number to the merchant to process the payment. Thus, the user does not have to visit the website of the interchange (101) to complete the payment.

In one embodiment, the server (113) presents the payment option (205) via an online shopping cart system or a third party checkout system. Alternatively or in combination, the server (113) presents the payment option (205) via a web widget. For example, a web widget may include a program code that is portable and executable within a web page without requiring additional compilation. The web widget allows the user to select the option (205) to pay for the product and/or service without leaving the web page or refreshing the web page. In one embodiment, the interchange (101) provides the web widget to facilitate the payment processing.

FIG. 8 illustrates a user interface to initiate a payment request according to one embodiment, after the payment request is redirected to the website of the interchange (101). In FIG. 8, the user interface (201) includes the identity of the merchant and the amount (203) of the requested payment. The user interface (201) includes a text field (183) to allow the user to provide the phone number (123) to identify the account information (121) via its association with the phone number (123) in the data storage facility (107).

Further, user authentication may be used to reduce false messages to the phone number (123). For example, the user interface (201) may request a PIN for enhanced security. For example, the user may be required to register with the interchange (101) prior to using the services of the interchange (101); and after registering with the interchange (101), the user is provided with the PIN or can created a customized PIN to access the functionality provided by the user interface (201).

Alternatively, the user interface (201) may request an identifier associated with the phone number (123) to initiate the payment transaction. In some embodiments, the user interface (201) requires the user to provide no information other than the phone number (123) in the text field (183) to initiate the transaction.

In FIG. 8, the user interface (201) allows the user to select one option from a plurality of payment options, including paying via the phone bill, and paying via one or more of the accounts identified by the account information (121) associated with the phone number (123) in the data storage facility (107).

In some embodiments, the user interface (201) may present the payment options after authenticating the user (e.g., via a personal identification number or password) for enhanced security.

In some embodiments, the user interface (201) identifies the different accounts represented by the account information (121) by showing aliases of the accounts. The aliases may be previously specified by the user, or be dynamically generated by the interchange (101) based on the types of the accounts and/or portions of the account information (121) (e.g., the first or last few digits of the account number, etc.)

In one embodiment, once the user submits the payment request via the user interface (201), the interchange (101) transmits a confirmation message to the mobile phone (117) according to the phone number (123) provided in the text field (183). In one embodiment, the interchange (101) transmits the confirmation to the mobile phone (117) after the user is authenticated via the user interface (201) to reduce the possibility of unauthorized/unwelcome messages to the mobile phone (117), which may occur when the user intentionally or unintentionally provides an unrelated phone number in the entry box (183).

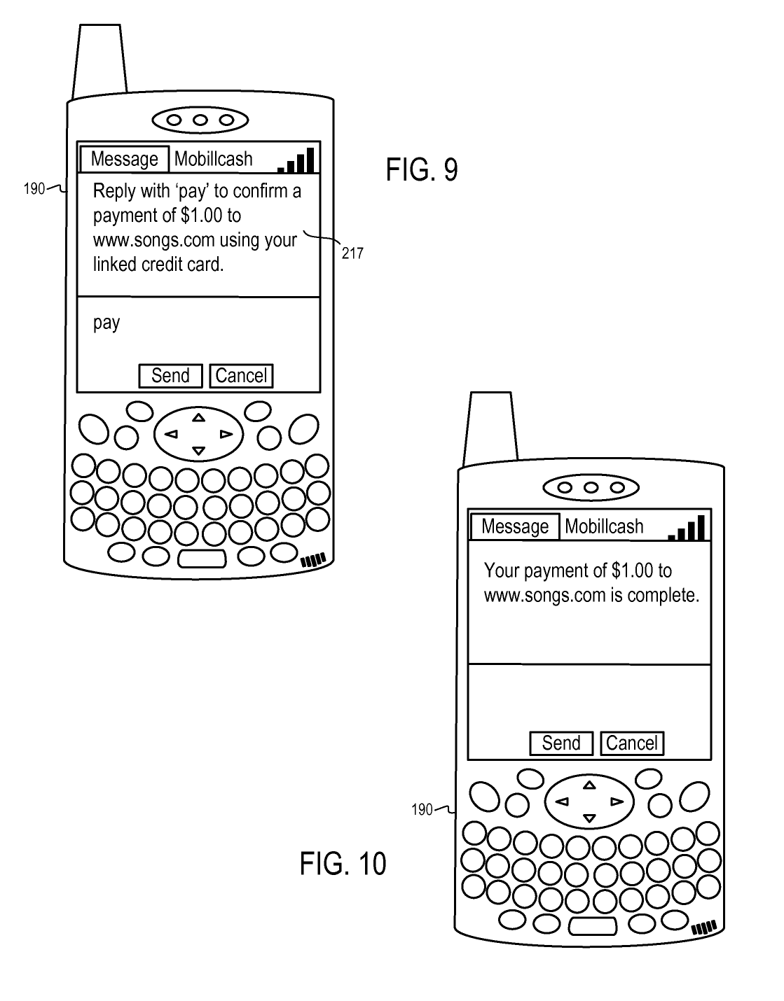

FIG. 9 illustrates a user interface to confirm a payment request according to one embodiment. In FIG. 9, the confirmation message (217) includes the amount (203) of the requested payment and the identity of the payee (e.g., a merchant operating the server (113)).

In one embodiment, the confirmation message (217) includes the instruction to reply with a code, such as a code (e.g., “pay”) provided in the confirmation message (217) as illustrated in FIG. 9.

The presence of the code in the reply message is an indication of the user approving the request; and the requirement for such a code in the reply eliminates false confirmations (e.g., generated via accidental replies or automated replies).

Alternatively or in combination, the requested code may include a PIN associated with the account, and/or a code (not shown) randomly generated and presented in the user interface used to initiate the payment transaction (e.g., user interface (201)).

In some embodiments, the code requested in the text message (217) may be a personal identification number (PIN) associated with the phone number (123). The text message (217) does not include the code; and the knowledge of the code is an indication of the identity of the user. Thus, the use of such a code increases the security of the transaction.

In a further embodiment, the code requested in the text message (217) includes a code that is provided in response to the payment request (e.g., via the user interface (201), not shown in FIG. 8). The code may be generated randomly at the time the request is received via the user interface (201), or when the user interface (201) is presented to the user. The code provided to the user interface (201) can be requested in the reply received from the user interface (190) to indicate that the user who is in possession of the mobile phone (117) has actual knowledge about the payment request submitted via the user interface (201).

After the correct reply is received, the interchange (101) communicates with the account server (125) to electronically charge the user using the account information (121) and pays the payee using the funds collected via communicating with the account server (125). The interchange (101) then notifies the user when the payment transaction is complete.

For example, the interchange (101) may notify the user via a text message to the mobile phone (117), as illustrated in FIG. 10. FIG. 10 illustrates a user interface to confirm the completion of a payment transaction according to one embodiment. No reply to the message that confirms the completion of the payment transaction is necessary. Once the payment transaction is complete, the user would have access to the product purchased via the payment transaction.

In one embodiment, the interchange (101) stores an address of the user associated with the phone number (123). After the completion of the payment transaction, the interchange (101) provides the address to the server (113) of the merchant for the delivery of the purchased product. In some embodiments, the user may provide multiple addresses associated with the phone number (123) and may select one as a delivery address in the confirmation/approve message to the interchange (101). Alternatively, the interchange (101) may receive an address for product delivery from the mobile phone (117) together with the confirmation/approve message and then forward the address to the server (113) of the merchant. Thus, the shipping address of the transaction is verified to be associated with the mobile phone (117). In alternative embodiments, the user may directly provide the shipping address in the website hosted on the server (113) of the merchant.

In other embodiments, the user is provided with the options to pay via the mobile phone bill associated with the phone number (123). The interchange (101) may dynamically calculate a set of premium messages, based on a set of limited number of predetermined prices for premium messages, to match the purchase price. The interchange (101) sends the set of premium messages to the mobile phone (117) at the phone number (123) to collect the funds via the telecommunication carriers to pay for the purchases. Thus, the purchase prices are not limited to the set of predetermined prices for premium messages. In some embodiments, the interchange (101) may send the set of premium messages in a period of time (e.g., a week, a month, a number of mouths, etc.) to spread the payments over the period of time (e.g., to overcome budget limits and/or limits imposed by regulations).

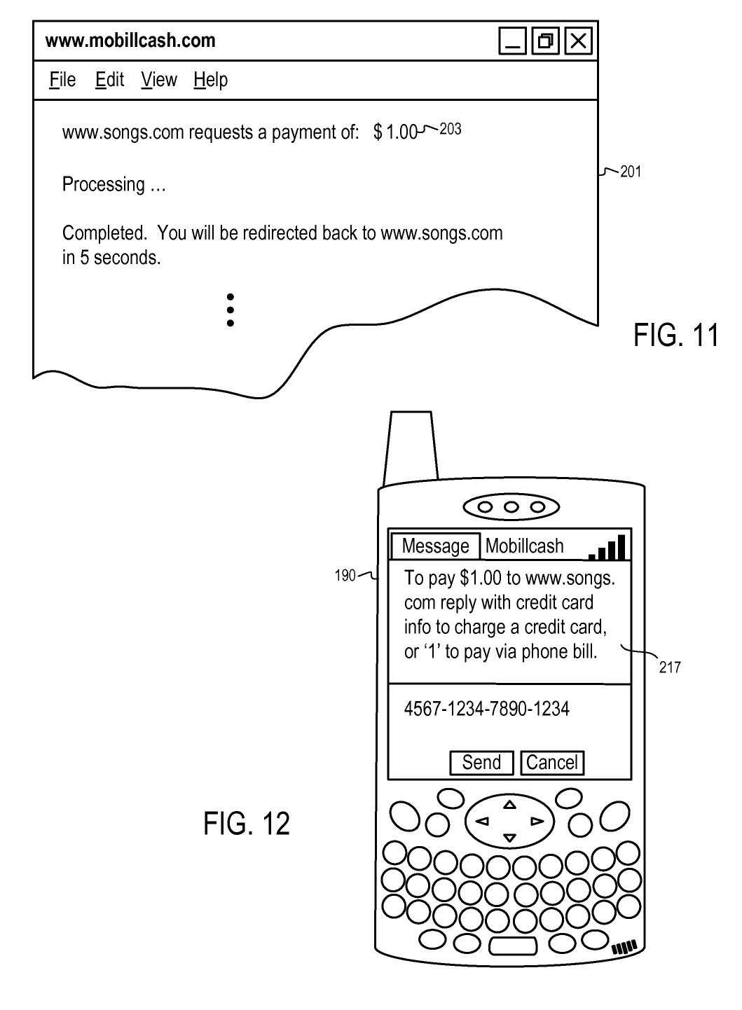

FIG. 11 illustrates a way to redirect a payment confirmation according to one embodiment. For example, after the user submits the payment request to the interchange (101) via the user interface (201) shown in FIG. 8, the interchange (101) may present the user interface (201) illustrated in FIG. 11 to the user. The user interface (201) indicates that the request is being processed; and the user interface (201) is periodically updated to show progress. Once the payment transaction is completed, the user interface (201) provides a confirmation message and may automatically redirect the user back to the website of the payee (e.g., to access the purchased products or services).

In one embodiment, the user is required to provide the approval in response to the confirmation message (217), as illustrated in FIG. 9, within a predetermined period of time. If the user fails to provide the approval from the mobile phone (117) within the predetermined period of time, the payment request may be rejected; and the user interface (201) may present a message indicating the failure and then redirect the user back to the website of the payee.

In some embodiments, instead of redirecting the user back to the website of the payee after the expiration of a predetermined period of time (e.g., after the failure of the payment process, or after the completion of the payment), the user interface (201) may provide a link to the website of the payee to allow the user to manually select the link to go back to the website of the payee to continue the process at the website of the payee.

FIG. 12 illustrates a user interface to receive payment options according to one embodiment. In FIG. 12, the interchange (101) sends a message (217) to the mobile phone (117) to provide a number of options to the user. The message (217) identifies the amount (203) of the requested payment and the identity of the payee (e.g., a merchant operating the server (113)) and asks the user to approve the payment request via a reply that contains a selected payment option.

In FIG. 12, the user may reply with the code “1” to approve the payment request and to pay via the phone bill of the mobile phone (117). Alternatively, the user may reply with the credit card information to charge the payment to a credit card, as illustrated in FIG. 12.

In one embodiment, if the user provides credit card account information in the approval message, the credit card account information is stored and associated with the phone number (123) in the data storage facility (107). Thus, in subsequent approval messages, the user does not have to supply the same information again.

For example, the data storage facility (107) may store account information for each of a plurality of account types (e.g., Visa, MasterCard, checking, savings, etc.) Thus, each of the accounts can be identified to the user via the account type in the confirmation message, without revealing the details of the account information.

For example, the interchange (101) may combine the name of the financial institutions and the type of accounts to generate aliases for the account information.

In some embodiment, the user may define the aliases for the account information by supplying the aliases with the account information (121) for association with the phone number (123).

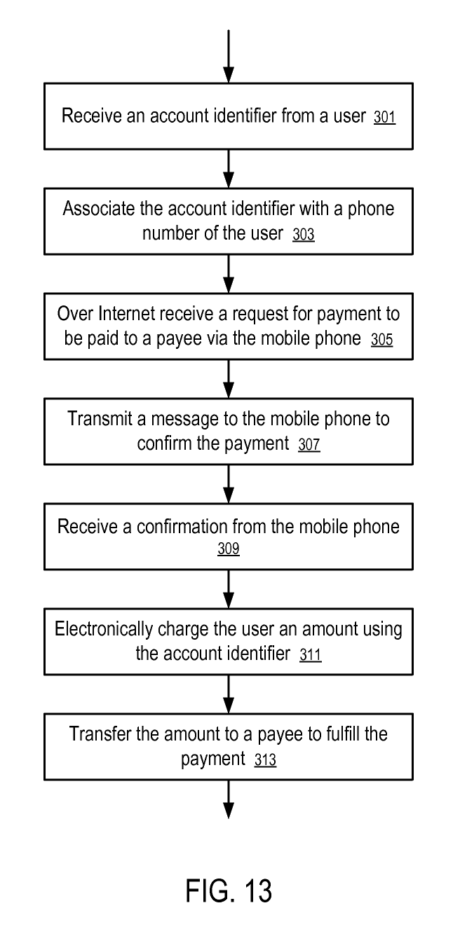

FIG. 13 shows a method to process an online payment according to one embodiment. In FIG. 13, the interchange (101) receives (301) an account identifier (e.g., 121) from a user and associates (303) the account identifier with a phone number (123) of the user in the data storage facility (107). Over the Internet the interchange (101) subsequently receives (305) a request for payment to be paid to a payee via the mobile phone (117) identified by the phone number (123). In response to the request, the interchange (101) transmits (307) a message (217) to the mobile phone (117) to confirm the payment.

After receiving (309) a confirmation or approval from the mobile phone (117) for the payment, the interchange (101) electronically charges (311) the user an amount using the account identifier (e.g., via communicating with the account server (125) using the account identifier). The interchange (101) then transfers (313) the amount to a payee to fulfill the payment.

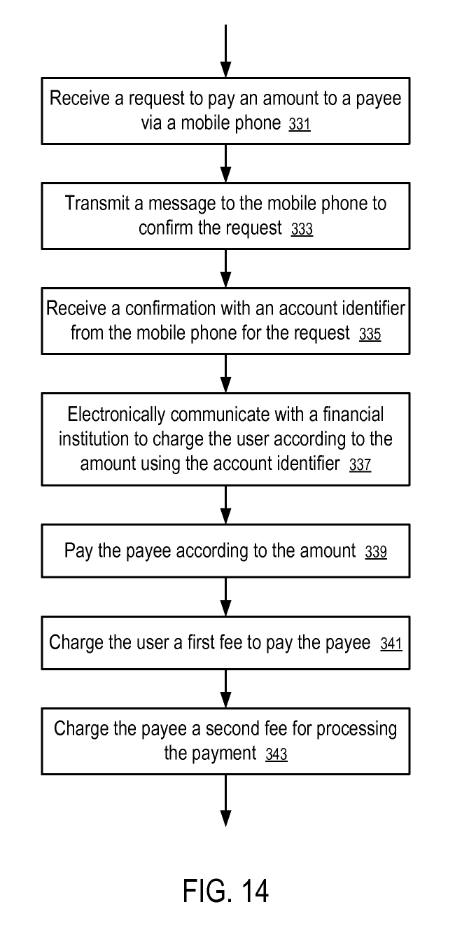

FIG. 14 shows another method to facilitate a payment transaction according to one embodiment. In FIG. 14, the interchange (101) receives (331) a request to pay an amount to a payee via a mobile phone (117). The interchange (101) transmits (333) a message (217) to the mobile phone (117) to confirm the request via the converter (131) corresponding to the controller (115) of the mobile phone (117).

After the interchange (101) receives (335) a confirmation with an account identifier (e.g., 121) from the mobile phone (117) for the request, the interchange (101) electronically communicates (337) with a financial institution to charge the user the specified amount using the account identifier. The interchange (101) pays (339) the payee according to the amount, optionally charges (341) the user a first fee to pay the payee, and optionally charges (343) the payee a second fee for processing the payment.

In one embodiment, the users are given an incentive to provide the account information (121) for electronic payments via the account servers (125). For example, the interchange (101) may charge a lower fee for fulfilling payment requests via the account server (125) than for fulfilling payments requests via the phone bill. For example, the interchange (101) may offer rebates, discounts, etc. to the users who provide the account information (121). In some embodiments, the interchange (101) can complete a payment process via the account server (125) with fewer restrictions than via the phone bill.

In one embodiment, the merchant may specify the second fee. Different merchants may offer different percentages of the purchase prices as the second fee; and the interchange (101) may calculate the first fee based on the second fee offered by the merchant, by deducting the second fee from the total fees to be charged (e.g., fees charged by the telecommunication carrier for collecting the funds via the mobile phone bill associated with the telephone number and/or the fees charged by the interchange (101) for processing the payments). Since the first fee is charged to the customer (e.g., the purchaser of products and services), the cost to the customer can vary based on the selection of the merchant. For the same purchase prices, the first fee (and thus the cost to the customer) may be different for purchases made via different merchants, because the merchants may offer different percentage of the purchase price as the second fee. In some embodiments, the first and second fees include both fees charged by the telecommunication carrier for collecting the funds via the mobile phone bill/account associated with the phone number (123) and the fees charged by the interchange (101) for processing the payments. In some embodiments, the first fee includes the fees charged by the telecommunication carrier but no fees charged by the interchange (101). In some embodiments, the second fee includes the fees charged by the telecommunication carrier but no fees charged by the interchange (101). In some embodiments, the first fee and/or the second fee do not include the fees charged by the telecommunication carrier. In some embodiments, the first fee is not charged; and in other embodiments, the second fee is not charged.

In one embodiment, a personal identification number (PIN) is used in the confirmation of a transaction. The PIN may be stored in the user account hosted on the data storage facility (107) of the interchange (101), and be associated with the phone number (123) and/or the account information (121). For example, a user requesting a transaction using the funds associated with the phone number (123) may be required by the interchange (101) to present the correct PIN associated with the phone number (123).

In some embodiments, the PIN may be the same as a PIN used by a third party to control access to products and/or services for the user having the phone number (123). For example, the PIN for accessing the voice mail of the phone number (123) can be used by the interchange (101) to verify the identity of the user who attempts to use the funds associated with the phone number (123). For example, the interchange (101) may receive a PIN from the user and communicate with a telecommunication carrier of the phone number (123) to verify whether the received PIN is a correct PIN for accessing the voice mail of the phone number (123).

In some embodiments, a correct PIN is stored on the mobile phone (117) to control access to the services of the interchange (101). For example, an application running on the mobile phone (117) may prompt the user to provide a PIN and check the PIN received from the user against the correct PIN stored on the mobile phone (117) to determine whether the user is authorized to use the mobile phone (117) to access the services of the interchange (101). In some embodiments, the PIN is specific for the control of access to the services of the interchange (101). Without the PIN, the user may use other functions of the mobile phone (117), such as making phone calls, sending emails or text messages, etc. When it is determined that the user is authorized to use services of the interchange (101) via the mobile phone (117), the application allows the user to send a confirmation message to the interchange (101) to confirm a transaction, or to display a code received from the interchange (101) for the confirmation of the transaction via presenting the code in a web page of the interchange (101).

In some embodiments, the interchange (101) requires the user to provide the PIN associated with the phone number (123) via the mobile phone (117) at the phone number (123) to confirm a transaction. The user may provide the PIN to the mobile phone (117) which transmits the received PIN to the interchange (101) for verification. The user may provide the PIN in response to a message from the interchange (101) to the mobile phone (117) at the phone number (123), or in response to the interchange (101) presenting a request on the user terminal (111) to request the user to send to the interchange (101) a confirmation message from the mobile phone (117) at the phone number (123). Alternatively, the user may provide the correct PIN in the user terminal (111) to obtain a confirmation code, which is to be transmitted from the mobile phone (117) at the phone number (123) to confirm the transaction.

In some embodiments, the user may provide the correct combination of the PIN and the phone number (123) to the user terminal (111) to request a transaction, without the need to further confirm the request via the mobile phone (117).

In one embodiment, to further improve security, the communications from the mobile phone (117) at the phone number (123) further include an identification number stored on the mobile phone (117) (e.g., in an integrated circuit (IC) chip). For example, a software program (e.g., a Java application) can be used to read a hardware identification number from the IC chip of the mobile phone (117) and transmit a confirmation message including the hardware identification to indicate that the message is indeed from a mobile phone (117) registered with the user.

In one embodiment, the International Mobile Equipment Identity (IMEI) of the mobile phone (117) is used as the hardware identification number. Alternatively, a hardware identification number may be assigned to and stored into the mobile phone (117) when the mobile phone (117) is initially configured for the services of the interchange (101) (e.g., when the application is installed on the mobile phone (117)).

In one embodiment, when the mobile phone (117) at the phone number (123) is registered for the services of the interchange (101), a software application is installed and/or configured on the mobile phone (117). The software application can be implemented using Java programming language in one embodiment. Other programming languages can also be used. Further, in some embodiments, the application can be implemented via hardware circuits, such as Application-Specific Integrated Circuit (ASIC) or Field-Programmable Gate Array (FPGA), or a combination of special purpose hardware circuits and instructions.

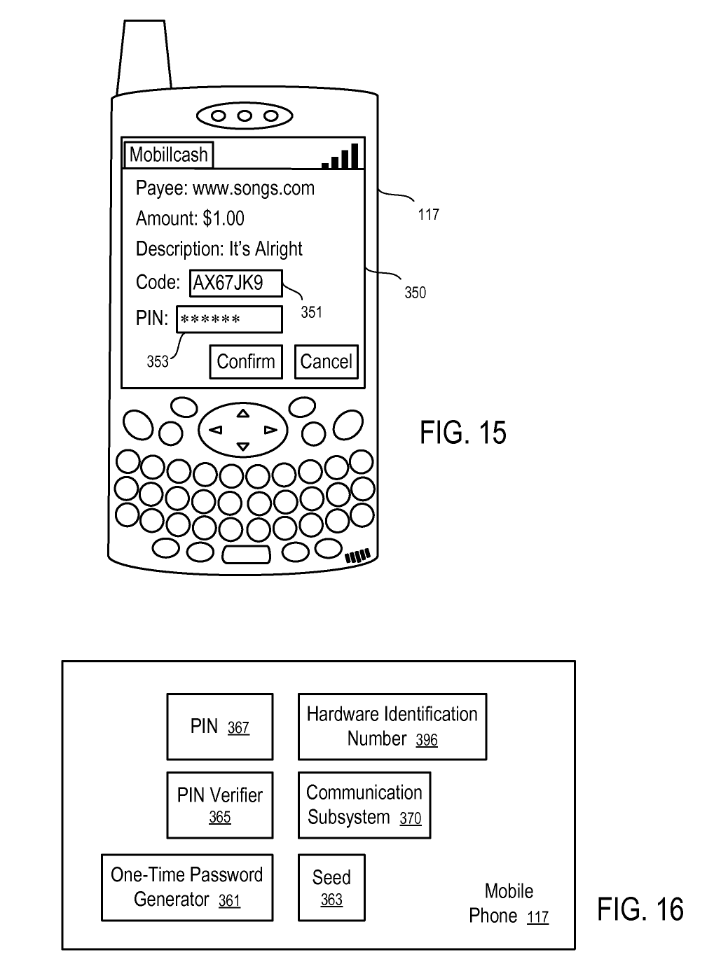

In one embodiment, the application is configured on the mobile phone (117) to present a user interface (350) to confirm a transaction according to one embodiment, as illustrated in FIG. 15. In FIG. 15, the application communicates with the interchange (101) to present information that identifies aspects of the transaction, such as the payee, the amount involved in the transaction, a description of the product or service in the transaction, etc.

In FIG. 15, the user interface (350) includes an entry box (353) to receive a PIN from the user. When the PIN received in the user interface (350) is invalid, the user interface (350) may reject the input and prevent the user from sending the confirmation message via the user interface (350).

Alternatively, the user interface (350) may accept the user input without checking the input for validity and transmit the confirmation with the received PIN to the interchange (101). The interchange (101) then checks the received PIN for validity. If the interchange (101) determines that the received PIN is valid for the phone number (123) of the mobile phone (117), the interchange (101) accepts the confirmation and performs the requested transaction. If the interchange (101) determines that the received PIN is invalid, the user interface (350) may prompt the user to re-enter the PIN.

In some embodiments, the user interface (350) and/or the interchange (101) may prevent the user from using the user interface (350) after the user fails to provide the correct PIN after a predetermined number of attempts.

In FIG. 15, the user interface (350) further includes an entry box for the user to enter a code (351) that represents the transaction. For example, when the user uses the user terminal (111) to submit a transaction request (e.g., via a web browser), the interchange (101) provides the code (351) as an identifier of the transaction.

In one embodiment, after the user enters the code (351) in the entry box, the application running the user interface (350) communicates with the interchange (101) to obtain the information about the transaction, such as the payee, the amount of the transaction, a description, etc. Thus, providing the code (351) in the entry box allows the user to see in the user interface (350) the information specific to the transaction for the confirmation of the correct transaction.

In one embodiment, the code (351) is a one-time code, which expires after the code is submitted to the interchange (101). To improve security, the interchange (101) may cause the one-time code (351) to expire after a predetermined period of time from when the one-time code (351) is provided by the interchange (101) to the user. When the one-time code (351) or the PIN is incorrect, the interchange (101) rejects the confirmation. After an incorrect combination of the PIN and the one-time code (351) is received, the interchange (101) may cause the one-time code (351) to expire; and the user is prompted to resubmit the transaction request to obtain a new one-time code.

In some embodiments, the interchange (101) may allow the user interface (350) to resubmit the input for the PIN a number of times if the one-time code (351) is valid. For example, the user interface (350) may be presented in response to a message from the interchange (101) requesting the confirmation of the transaction. The one-time code (351) is required in the entry box to ensure that the user has knowledge about the transaction submitted via the user terminal (111). The PIN is required in the entry box (353) to ensure that the user is authorized. In some embodiments, the one-time code (351) is optional.

In some embodiments, the interchange (101) provides the one-time code (351) to the user via the user interface (350). The application may send the one-time code (351) back to the interchange (101) to identify the transaction being confirmed by the user.

Alternatively, the interchange (101) may require the user to provide the one-time code (351) back to the interchange (101) via the user terminal (111) that submits the corresponding transaction request. After the one-time code (351) shown in the user interface (350) on the mobile device (117) is transmitted from the user terminal (111) to the web server of the interchange (101), the transaction is confirmed with the interchange (101).

In one embodiment, the PIN is used to protect access to the one-time code (351). The user interface (350) is configured to display the one-time code (351) after the user enters the correct PIN in the entry box (353). If the user fails to enter the correct PIN in the entry box (353), the user interface (350) does not display the one-time code (351) which is required in the user terminal (111) to confirm the transaction.

In one embodiment, the code (351) is a one-time password, which is generated on the mobile phone (117). The one-time password is provided to the interchange (101) to confirm the transaction (e.g., via the mobile phone (117) communicating with the interchange (101), or via the user terminal (111) communicating with the interchange (101)).

In one embodiment, the one-time password is generated on the mobile phone (117) after the request for the transaction is submitted to the interchange (101) via the user terminal (111). The one-time password is not received in the mobile phone (117) from the interchange (101) as a result of the transaction request. In one embodiment, the one-time password is generated based at least in part on a seed that is configured in the mobile phone prior to the transaction.

In one embodiment, the one-time password is generated on the mobile phone (117) after the PIN is verified in the entry box (353). If the PIN entered in the entry box (353) is invalid, the mobile phone (117) does not generate the one-time password.

In one embodiment, the user is instructed to use the one-time password to authenticate with the interchange (101), using the user terminal (111) that submits the request for the transaction. Alternatively, the mobile phone (117) may transmit the one-time password to confirm the transaction. In some embodiments, the mobile application generates the one-time password and transmits the one-time password to the interchange (101) to confirm the transaction, without displaying the one-time password to the user, after the user enters the correct PIN.

In one embodiment, the correct PIN is stored on the mobile phone (117) (e.g., in an encrypted format). Thus, the user interface (350) can verify the PIN entered in the entry box (353) without communicating with the interchange (101).

Alternatively, the correct PIN may be stored on the data storage facility (107) of the interchange (101). The application running on the mobile phone (117) communicates the PIN received in the entry box (353) to the interchange (101) (e.g., in an encrypted format) for verification.

Alternatively, a third party may store the correct PIN (e.g., for controlling access to the voice mail of the phone number (123)). After the interchange (101) obtains the PIN received in the entry box (353), the interchange (101) communicates with the third party to verify the PIN.

FIG. 16 illustrates a mobile phone configured to confirm transactions according to one embodiment. In FIG. 16, the mobile phone (117) includes a hardware identification number (396) which identifies the mobile phone (117). In one embodiment, the hardware identification number (396) is configured and stored on the mobile phone (117) prior to the mobile phone (117) being distributed to end users. For example, the hardware identification number (396) may include International Mobile Equipment Identity (IMEI) and/or Media Access Control address (MAC address).

In some embodiments, the hardware identification number (396) includes a number that is assigned to the mobile phone (117) when the mobile phone (117) is registered with the interchange (101) for the services provided by the interchange (101). For example, the interchange may use an application to write the assigned number into an integrated circuit (IC) chip in the mobile phone to identify the mobile phone (117). In some embodiments, the assigned number is written into a removable memory module to represent the registered mobile phone (117).

In FIG. 16, the mobile phone (117) includes a seed (363) for the one-time password generator (361). The one-time password generator (361) is configured to generate a series of passwords for authenticating with the interchange (101), based on the seed (363) and/or the current time. Thus, the one-time password generated on the mobile phone (117) is in synchronization with the corresponding one-time password generated or used on the interchange (101). Alternatively, the one-time password generator (361) may not rely upon the current date and time for synchronization; and the interchange (101) is configured to tolerate skipping of up to a predetermined number of one-time passwords to accept a one-time password from the mobile phone (117).

In one embodiment, the PIN verifier (365) is configured to check the PIN received in the entry box (353) against the PIN (367) stored on the mobile phone (117). After the PIN verifier (365) determines that there is a match between the PIN (367) stored on the mobile phone (117) and the PIN received in the entry box (353), the communication subsystem (37) transmits a one-time password obtained from the one-time password generator (361) and the hardware identification number (396) to the interchange (101) to confirm the transaction. In one embodiment, the one-time password is used to encrypt the confirmation transmitted from the mobile phone (117) to the interchange (101) to confirm the transaction.

The mobile phone (117) may transmit the confirmation message to the interchange (101) via short message service (SMS), email, a WAP request, or a web request. Other communication protocols can also be used.

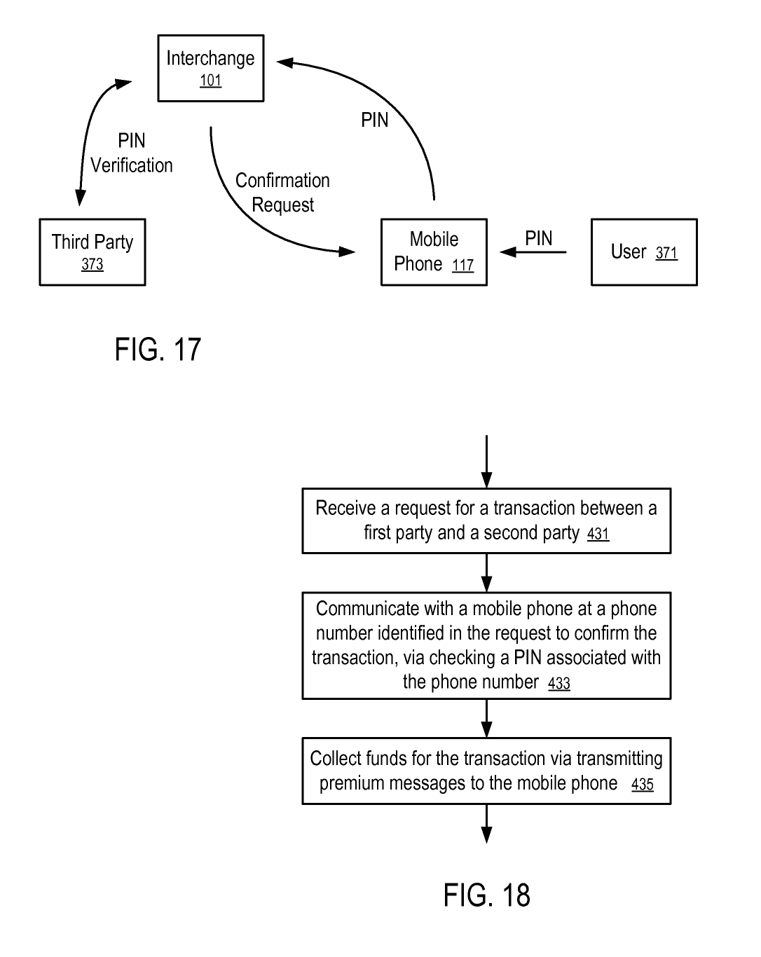

FIGS. 17-19 illustrate methods to confirm transactions according to one embodiment.

In FIG. 17, neither the interchange (101) nor the mobile phone (117) stores the correct PIN associated with the phone number of the mobile phone (117). A third party (373) stores the correct PIN associated with the phone number (123) of the mobile phone (117). To confirm a transaction, the interchange (101) transmits a message to the mobile phone (117) at the phone number (123) to request a confirmation message from the mobile phone (117). The mobile phone (117) presents a user interface (e.g., 350) to receive an input for the PIN from the user (371) and transmits the received PIN to the interchange (101), which further communicates with the third party (373) to verify whether the received PIN matches the correct PIN. Thus, the user may use the same PIN for multiple services associated with the phone number (123), such as accessing voice mail at the phone number (123) and paying for purchases using funds associated with the phone number (123).

In FIG. 18, after a request for a transaction between a first party and a second party (431) is received in the interchange (101) (e.g., via a web server), the interchange (101) communicates (433) with the mobile phone (117) at a phone number (123) identified in the request to confirm the transaction, via checking a PIN associated with the phone number (123). The transaction is confirmed if a PIN entered into the mobile phone (117) by the user of the mobile phone (117) is correct. After the transaction is confirmed, the interchange (101) collects (435) funds for the transaction via transmitting premium messages to the mobile phone (117).

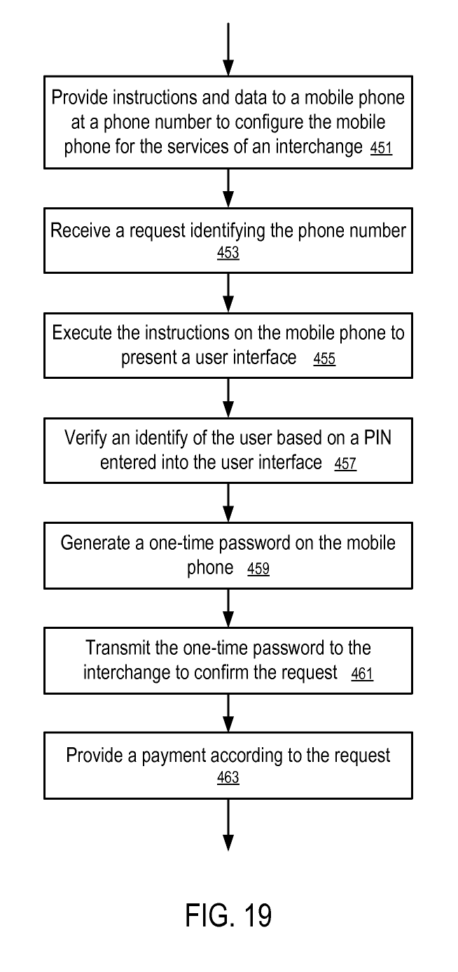

In FIG. 19, the interchange (101) provides (451) instructions and data to a mobile phone (117) at a phone number (123) to configure the mobile phone (117) for the services of the interchange (101). The instructions may be in Java programming language, or other programming languages. The data may include a seed (363) for the one-time password generator (361) and/or a portion of the hardware identification number (396). For example, the user may use the mobile phone (117) to download the instructions and data from the interchange (101).

After the mobile phone (117) is configured via the instructions and data, the interchange (101) may receive (453) a request identifying the phone number (123) and transmit a message to the user (371) to cause the mobile phone (117) to execute (455) the instructions on the mobile phone (117) to present a user interface (350). After the identify of the user (371) is verified (457) based on a PIN entered into the user interface (350), the mobile phone (117) generates (459) a one-time password on the mobile phone (117) and transmits (461) the one-time password to the interchange (101) to confirm the request. Once the request is confirmed via the confirmation transmitted from the mobile phone (117), the interchange (101) provides (463) a payment according to the request (e.g., using funds associated with the phone number (123)).

In one embodiment, the interchange (101) includes a server computer. The server computer may be used to receive a request for a transaction between a first party and a second party. The request includes the indication of a phone number of the first party and an amount to be paid to the second party.

In response to the request, the server computer communicates with a mobile phone (117) at the phone number (123) to confirm, via a personal identification number of the first party, the transaction. After the transaction is confirmed via the personal identification number of the first party, the server computer transmits one or more premium messages to the mobile phone (117) to collect, via a telecommunication carrier of the mobile phone (117), funds in accordance with the amount to be paid to the second party.

In one embodiment, the interchange (101) provides instructions to the mobile phone (117). When executed, the instructions cause the mobile phone (117) to present a user interface to receive a first personal identification number.

The instructions may further cause the mobile phone (117) to encrypt the first personal identification number for transmission from the mobile phone (117) to the server computer. The server computer is to compare the first personal identification number with a second personal identification number associated with the phone number (123) of the mobile phone (117) to determine whether the transaction is confirmed.

Alternatively, the instructions may further cause the mobile phone (117) to compare the first personal identification number with a second personal identification number stored on the mobile phone (117) to determine whether the first personal identification number is correct. After determining that the first personal identification number is correct, the instructions further cause the mobile phone (117) to transmit a message to the server computer to confirm the transaction .

In one embodiment, the instructions further cause the message to include a hardware identification code of the mobile phone (117). The hardware identification code may be provided to the mobile phone (117) in a read-only memory, before the mobile phone (117) is distributed to an end user. For example, the hardware identification code may include International Mobile Equipment Identity (IMEI).

In some embodiments, the hardware identification code is provided to the mobile phone (117) when the mobile phone (117) is registered with the server computer for services offered by the server computer.

In one embodiment, the instructions further cause the mobile phone (117) to transmit the message to the server computer via short message service (SMS). In some embodiments, the message includes a one-time password generated via the instructions. For example, the one-time password can be generated based on a current time; and the server computer is to determine whether the one-time password is generated by the mobile phone (117). When the one-time password matches a series of passwords configured to be generated by the mobile phone (117), the one-time password is accepted. In one embodiment, the server computer provides to the mobile phone (117) at the phone number (123), a seed for generation of the one-time password, which is used by the instructions to generate the one-time password.

In one embodiment, the server computer provides the first party with a seed for one-time password generation when the first party registers for services of the server computer; and the instructions cause the mobile phone (117) to present a user interface to receive the seed.

In one embodiment, the server computer is to further communicate with a third party to determine whether the first personal identification number received in the user interface is associated with the phone number (123) of the mobile phone (117). For example, the third party may be a telecommunication carrier of the mobile phone (117); and a correct personal identification number is used by the telecommunication carrier to control access to voice mails for the phone number (123).

In one embodiment, the request is received in a web server of the server computer; the server computer communicates with the mobile phone (117) to provide a one-time code to the mobile phone (117), after the personal identification number of the first party is verified via the mobile phone (117); and the server computer is configured to receive the one-time code back in the web server to confirm the transaction.

In one embodiment, the request is received in a web server of the server computer; the server computer provides a one-time code via the web server to the first party; and the server computer is configured to determine whether the transaction is confirmed based on receiving, from the mobile phone (117), both the personal identification number of the first party and the one-time code.

In one embodiment, the interchange (101) is used to facilitate user authentication for signing in accounts on servers (113) that may be operated by entities different from the entity that operates the interchange (101). The interchange (101) can also be used for user authentication at a server (113) when the server (113) is operated by the same entity that operates the interchange (101).

For example, in one embodiment, a user can provide a mobile phone number (123) to identify the user for signing into an account-based service hosted on the server (113). The user can use the mobile phone number (123) to make a request to login; and the interchange (101) communicates with the mobile phone (117) at the mobile phone number (123) to authenticate the identity of the user for the system hosted on the server (113). The user can use the mobile phone (117) to complete the authentication to access an application or service.

The mobile phone number (123) can be tied or bound to existing accounts and/or new accounts of the user, hosted on various servers (113), for authentication purposes. These accounts may have different type definitions and can vary depending on system setup. For example, the user can use the mobile phone number (123) to authenticate/login to a bank account, an online account, a credit card account, a checking account, an email account, etc. In one embodiment, the interchange (101) provides an Internet-based service to authenticate a mobile phone number (123) to an account and verify the identity of the user (e.g., using two-factor authentication or multi-factor authentication).

In one embodiment, the interchange (101) is further used to provide payments to the servers (113) for accessing the accounts or for accessing premium contents or features through the accounts. The interchange (101) may be used to pay for the purchases made via the accounts. Alternatively, the interchange (101) may provide the authentication service without having to use the funds associated with the mobile phone number (123) to make payments on behalf of the user.

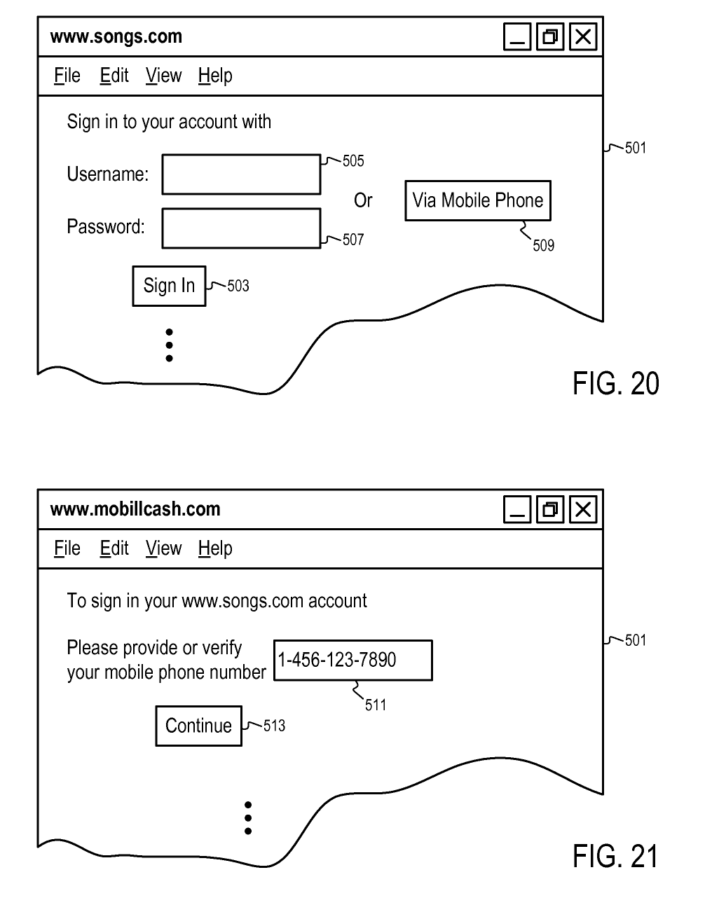

FIG. 20 shows a user interface to sign a user in according to one embodiment. In FIG. 20, the user interface is presented via a browser window (501) on the user terminal (111). The user interface allows the user to sign in by providing the username (505) and the password (507) and selecting the “sign in” button (503). In addition, the user is also allowed to select the button (509) to sign in via the mobile phone (117) of the user.

In some embodiments, the server (113) may not allow the user to sign in using the username (505) and the password (507) and may require the user to sign in via the mobile phone (117) of the user. Thus, the users of the server (113) do not have to use the username (505) and the password (507) created specifically for the server (113).

In one embodiment, after the user selects the button (509), the server (113) redirects the user to a website of the interchange (101) for authentication, as illustrated in FIG. 21.

FIG. 21 shows a user interface to obtain a phone number to sign a user in according to one embodiment. In FIG. 21, the website of the interchange (101) promotes the user to provide or verify the phone number (123) in the entry box (511).

In one embodiment, the website of the interchange (101) uses a browser cookie to store the phone number (123). Thus, after the user provides the phone number (123) in the entry box (511) to sign in one account via the interchange (101), the web page as illustrated in FIG. 21 can use the browser cookie to store the phone number (123) and automatically fill in the entry box (511) when the user is again redirected to the website of the interchange (101) (e.g., by the same server (113) to sign in the same account, or a different server to sign in a different account).

In another embodiment, the phone number (123) is provided by the web page after the user first provides the phone number (123) in the entry box (511) during a previous session of visiting the website of the interchange (101). The interchange (101) stores the phone number (123) in connection with an identification of the session such that when the user is redirected back to the website of the interchange (101) in the same session, the interchange (101) can automatically fill the entry box (511) with the phone number (123) previously provided in the session.

In one embodiment, when the user selects the button (513), the interchange (101) communicates with the mobile phone (117) at the phone number (123) to authenticate the user. For example, the interchange (101) can transmit a text message to the mobile phone (117) to request the PIN of the user from the mobile phone (117) at the phone number (123).

In some embodiments, the interchange (101) may require the user to sign in to the website of the interchange (101) (e.g., using a username and a corresponding password), when the phone number (123) is first received in the entry box (511) for a browser session. Such a requirement may be used to reduce or eliminate unintended spamming by the interchange (101), due to the user entering in the text entry box (511) a phone number that does not belong to the user. After the user signs in to the website of the interchange (101), the interchange (101) may pre-fill the entry box (511) based on profile information about the user stored on the data storage facility (107) of the interchange (101).

In some embodiments, the interchange (101) further authenticates the user via communicating with the mobile phone (117) at the phone number (123). For example, the interchange (101) can transmit a text message to the mobile phone (117) to request the PIN of the user from the mobile phone (117) at the phone number (123) to complete signing in to the website of the interchange (101).

In one embodiment, when the user is returning to a valid, previously authenticated browser session for the authentication process of a server (113), the interchange (101) may skip communicating with the mobile phone (117) for the authentication of the user. For example, when the user is retuning to a valid browser session on the website of the interchange (101) for signing into the server (113), the interchange (101) may request the user to present the password for the website of the interchange (101); and if the correct password is received, the mobile phone (117) may rely upon the previous communication with the mobile phone (117) in the valid browser session to complete the authentication for the server (113), without a new communication with the mobile phone (117) to confirm the identity of the user.

Alternatively, when the user is returning to the valid, previously authenticated browser session for the authentication into the server (113), the interchange (101) may skip the authentication via username and password on the website of the interchange (101), but still require the user to confirm identity via the mobile phone (117) at the phone number (123).

In some embodiments, when the user is returning to the valid, previously authenticated browser session for the authentication into the server (113), the interchange (101) may skip the need to further authenticate the user via the website of the interchange (101) and/or via the mobile phone (117).

In some embodiments, after the interchange (101) confirms the identity of the user via the mobile phone (117), the user on the user terminal (111) is signed in to the website of the interchange (101) until the user signs out, or the session is closed or expires.

In other embodiments, the interchange (101) may not require the user to sign in to the website of the interchange (101).

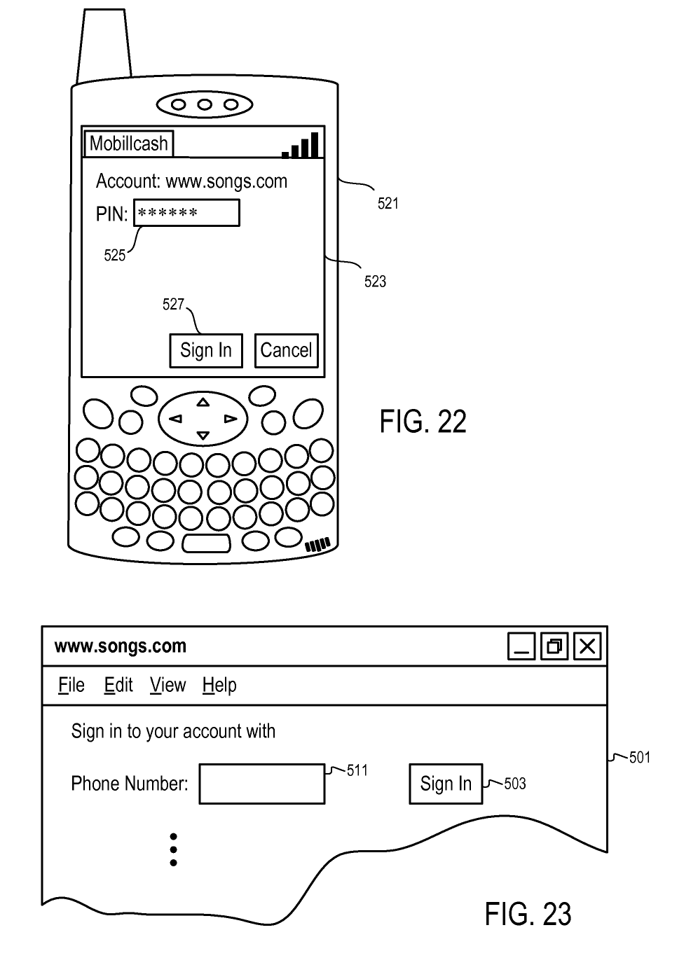

FIG. 22 shows a mobile user interface to confirm the identity of a user according to one embodiment. In FIG. 22, the user interface (521) is presented on the mobile phone (117) at the phone number (123) specified by the user to sign in. The message (523) presented in the user interface (521) identifies the server (113) (e.g., www.songs.com) which requested the interchange (101) to authenticate the user. The interface (521) requires the user to provide the PIN (525) to confirm the identity of the user.

In one embodiment, after the user selects the “sign in” button (527) in FIG. 22, the interchange (101) verifies the PIN (525) received via the mobile phone (117). If the correct PIN (525) is received from the mobile phone (117), the interchange (101) provides information to the server (113) to allow the user to sign in an account on the server (113).

In one embodiment, the user account on the server (113) is identified by the phone number (123) and/or the PIN (525). For example, in one embodiment, the phone number (123) is directly used to specify the account on the server (113). For example, a hash of the phone number (123), the PIN (525) and/or the identity of the server (113) can be used to represent the account of the user on the server (113).

In some embodiments, the phone number (123), the PIN (525) and/or the identity of the server (113) are used to look up an identifier of the account of the user on the server (113).

For example, in one embodiment, when a new account is created on the server (113) for the user, the user is redirected to the website of the interchange (101) for authentication or confirmation (e.g., via a user interface similar to that shown in FIG. 21). After the user request to create the new account is confirmed via the mobile phone (117), the user account is associated with the mobile phone (117) and/or the PIN (525).

For example, in one embodiment, when the user is redirected to the website of the interchange (101) for the confirmation, the identifier of the account can be provided from the server (113) to the website of the interchange (101) via the URL that redirected the request. After the interchange (101) receives the PIN (525) from the mobile phone (117), the identifier of the account is stored in the data storage facility (107) as part of the account info (121) associated with the phone number (123) and/or the PIN (525). In one embodiment, the account identifier is communicated from the server (113) to the interchange (101) via the web browser of the user in an encrypted format to prevent tampering and for increased security.

Alternatively, the server (113) may communicate the account identifier to the interchange (101) directly, without going through the user terminal (111). For example, the server (113) may provide a session identifier, or a request identifier, to the interchange (101) when the server (113) redirects the user to the website of the interchange (101). The server (113) separately communicates the account identifier associated with the session identifier, or the request identifier, directly to the interchange (101) (e.g., via an Application Programming Interface, or a web service). The session identifier, or the request identifier, thus allows the interchange (101) to associate the account identifier with the phone number (123) provided by the user.

In some embodiments, an existing account of the user can also be linked to the phone number (123) of the user in a similar way as linking a new account to the phone number (123).

In some embodiments, the server (113) may request the user to provide the correct username (505) and the password (507) in the user interface similar to that illustrated in FIG. 20, before the user is authenticated via the mobile phone (117). After the server (113) authenticates the user via the username (505) and the password (507), the server (113) requests the interchange (101) to further authenticate the user via the mobile phone (117). For example, in one embodiment, the button (509) is not displayed; and when the “sign in” button (503) is selected, the browser is directed or redirected to the website of the interchange (101) for authentication via the mobile phone (117).

In one embodiment, the server (113) may store the phone number (123) in the account of the user; and after the user is authenticated via the username (505) and the password (507), the server (113) may communicate with the interchange (101) in the background to request the interchange (101) to further authenticate the user via the mobile phone (117).

In some embodiments, the user may provide the phone number (123) to the server (113) to identify the account of the user; and the server (113) communicates with the interchange (101) in the background to request the interchange (101) to authenticate the user via the mobile phone (117), without redirecting the user to the website of the server (113), as illustrated in FIG. 23.

FIG. 23 shows another user interface to sign a user in according to one embodiment. In FIG. 23, the server (113) provides a user interface in the browser window (501). After the user provides the phone number (123) in the entry box (511) in the browser window (501), the user may select the “sign in” button (503) to request access. Before the server (113) allows the user to access the restricted areas of the account associated with the phone number (123) provided in the entry box (511), the server (113) communicates with the interchange (101) for user authentication via the mobile phone (117) at the phone number (123). For example, the user may be required to provide a PIN associated with the phone number (123) to pass the authentication process; the user may be provided with a one-time code via a web page presented in the web browser (501) and be instructed to provide the one-time code back to the interchange (101) via the mobile phone (117) at the phone number (123); and/or the user may be provided with a one-time code via the mobile phone (117) at the phone number (123) and instructed to provide the one-time code back to the website of the server (113) via the web browser (501). In some embodiments, the one-time password generated on the mobile phone (117), as discussed above, can be used in the authentication process.

In some embodiments, after the user selects the “sign in” button (503) in FIG. 23, the user is redirected to the website of the interchange (101) for a user interface as illustrated in FIG. 21.

In some embodiments, the user interface as illustrated in FIG. 21 is presented as a portion of the login page of the server (113).

In one embodiment, the user may initiate the login process via visiting a web page of the interchange (101), on which the user selects/identifies the server (113) the user wants to access and provides the phone number (123) to initiate the mobile phone (117) based on the authentication. After the interchange (101) completes the user authentication via the mobile phone (117) at the phone number (123), the interchange (101) identifies the account of the user at the server (113) and forwards the user to the server (113). The server (113) may or may not further authenticate the user.

In one embodiment, the user can sign in a browser session with a website of the interchange (101), authenticated via the mobile phone (117). From the authenticated session on the website of the interchange (101), the user can be forwarded to various different accounts of the user hosted on different servers (113), with or without being further authenticated by the respective servers (113). The interchange (101) automatically identifies the accounts of the user, based on the phone number (123) and/or the PIN of the user, to forward the user to the respective accounts on the servers (113).

In one embodiment, multiple users may share the same phone number (123) to access different, individual accounts of the users. The interchange (101) is configured to distinguish the user via different PINs of the users and/or different user identifiers. Alternatively, the interchange (101) may use only the phone number (123) to identify the user; and users not sharing the same accounts are required to use different phone numbers for mobile phone based authentication.

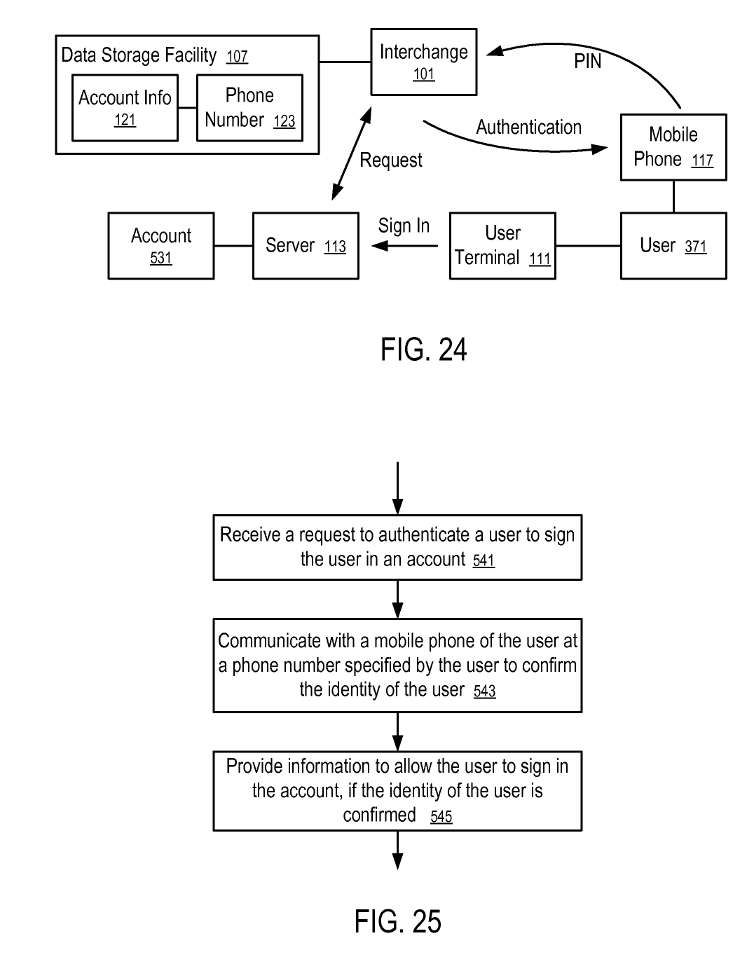

FIG. 24 shows a system to sign a user in according to one embodiment. In FIG. 24, the interchange (101) has a data storage facility (107) to store account information (121) associated with the phone number (123). The account information (121) may include a PIN associated with the phone number (123), data for a one-time password generated on the mobile phone (117) at the phone number (123) (e.g., the seed for the generation of one-time passwords), a one-time code presented to the user (e.g., via the web browser (501) or via the mobile phone (117)) that is to be received back from the user, the account identifiers of the user on different servers (113), etc.

In FIG. 24, the user (371) may use the user terminal (111) to sign in the account (531) hosted on the server (113). To authenticate the user (371), the interchange (101) transmits a message to the mobile phone (117) at the phone number (123) to request a PIN from the user (371). When the PIN received via the mobile phone (117) matches with the account information (121) stored on the data storage facility (107), the interchange (101) provides information to the server (113) to allow the user (371) to access the account (531) using the user terminal (111), which is typically a device distinct and separate from the mobile phone (117).

In some embodiments, the PIN received from the mobile phone (117) includes a one-time password received from the mobile phone (117). In some embodiments, the PIN includes a one-time code provided to the user (371) via the user terminal (111). In other embodiments, a one-time code is provided to the user (371) via the authentication message from the interchange (101) to the mobile phone (117); and the user (371) is requested to provide the one-time code back to the interchange (101) via the user terminal (111) (e.g., via the server (113), or directly to the website of the interchange (101)).

In one embodiment, the interchange (101) looks up the identifier of the account (531) from the account information (121), based on the phone number (123) and/or the PIN. The interchange (101) provides the account identifier to the server (113) to allow the user (371) to access the account (531) identified by the account identifier.

In some embodiments, the user (371) has multiple accounts on the server (113) that are associated with the phone number (123). The interchange (101) identifies the accounts to the server (113) to allow the user (371) to access any of the accounts, after the identity of the user (371) is verified via the mobile phone (117).

In one embodiment, the server (113) is configured to identify the account (531) based on the phone number (123); and the interchange (101) may communicate with the server (113) to indicate whether the user (371) failed or succeed in passing the authentication process.

FIG. 25 shows a method to sign a user in according to one embodiment. In FIG. 25, the interchange (101) receives (541) a request to authenticate a user (371) to sign the user (371) in an account (531). The interchange (101) communicates (543) with a mobile phone (117) of the user (371) at a phone number (123) specified by the user (371) to confirm the identity of the user (371). The interchange (101) provides (545) information to the server (113) to allow the user (371) to sign in the account (531) on the server (113), if the identity of the user (371) is confirmed via the interchange (101) communicating with the mobile phone (117).

In one embodiment, the request includes a web request from a browser (501) of the user (371), redirected from the host of the account (531) (e.g., server (113)) to the website of the interchange (101).

In one embodiment, the interchange (101) provides a user interface on the browser (501) of the user (371) to receive the phone number (123) specified by the user (371), as illustrated in FIG. 21.

In one embodiment, in communicating with the mobile phone (117), the interchange (101) receiving a personal identification number (PIN) from the mobile phone (117) of the user (371); and the identity of the user (371) is not confirmed by the interchange (101) if the PIN is not associated with the phone number (123) prior to the receiving of the request.

In one embodiment, the interchange (101) redirects the web browser (501) from the website of the interchange (101) to the server (113) hosting the account (531); and the information provided by the interchange (101) to the sever (113) includes an identifier to uniquely represent the user (371) among a plurality of users (or to uniquely identify the account (531) among a plurality of accounts hosted on the server (113)). In one embodiment, the identifier is generated from hashing the mobile phone number (123) and the PIN; in another embodiment, the identifier is pre-associated with the phone number (123) and the host.

In one embodiment, the account (531) is a new account of the user (371) created on the server (113) hosting the account (531); and the information provided from the interchange (101) to the server (113) associates the account identifier with an identifier representing the user (371). Subsequently, when the user (371) is authenticated by the interchange (101) via the mobile phone (117), the interchange (101) indicates to the server (113) that the user (371) represented by the user identifier has passed the authentication process, which allows the server (113) to grant the user (371) access to all accounts hosted on the server (113) and associated with the user identifier.

In one embodiment, the information is provided by the interchange (101) to the server (113) hosting the account (531) without going through the user (371). Alternatively, the information provided by the interchange (101) to the server (113) hosting the account (531) is communicated via redirecting the web browser (501) of the user (371).

In one embodiment, the request includes an identification code to identify a session initiated on the server (113) hosting the account (531) to sign in the user (371); and the information provided from the interchange (101) to the server (113) includes the identification code.

In one embodiment, the user (371) has a plurality of accounts on the server (113); and the information provided from the interchange (101) to the server (113) allows the user (371) to access the plurality of accounts.

In one embodiment, the interchange (101) determines an identifier of the account (531) based on the communicating with the mobile phone (117), and provides the identifier of the account (531) of the user (371) to the server (113) to allow the user (371) to access the account (531).

In one embodiment, the interchange (101) receives (541) the request, including the phone number (123), from the server (113) without going through the user (371). For example, based on the username identified by the user (371), the server (113) may look up the phone number (123) from the account (531) associated with the username to request the interchange (101) to authenticate the user (371) on behalf of the server (113). In some embodiments, the server (113) receives from the user (371) the phone number (123) as the username to access the account (531).

In one embodiment, the account (531) is funded by funds associated with the phone number (123) and paid by the interchange (101) to the server (113) on behalf of the user (371). For example, in one embodiment, the interchange (101) transmits one or more premium messages to the mobile phone (117) to collect the funds.

In one embodiment, the information allows the user (371) to sign in the account, without the user (371) paying the server (113) via the interchange (101).

In one embodiment, the account (531) hosted on the server (113) allows the user (371) to access at least one of: email, instant messaging, social networking, blogging, banking, online shopping, gaming, online communication, and content sharing.

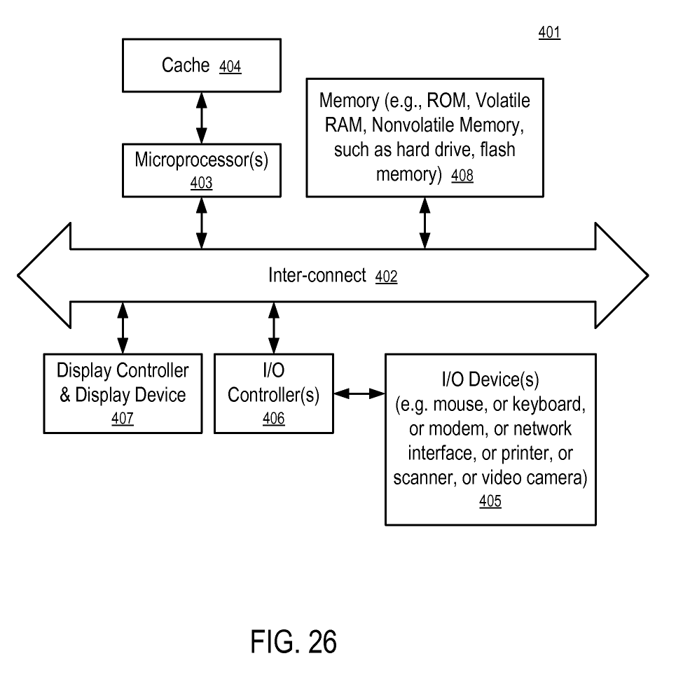

FIG. 26 shows a data processing system, which can be used in various embodiments. While FIG. 26 illustrates various components of a computer system, it is not intended to represent any particular architecture or manner of interconnecting the components. Some embodiments may use other systems that have fewer or more components than those shown in FIG. 26.

In one embodiment, each of the interchange (101), the data storage facility (107), the controllers (115), the mobile phones (117), the user terminals (111), the account server (125) and the servers (113) can be implemented as a data processing system, with fewer or more components, as illustrated in FIG. 26.

In FIG. 26, the data processing system (401) includes an inter-connect (402) (e.g., bus and system core logic), which interconnects a microprocessor(s) (403) and memory (408). The microprocessor (403) is coupled to cache memory (404) in the example of FIG. 26.

The inter-connect (402) interconnects the microprocessor(s) (403) and the memory (408) together and also interconnects them to a display controller, display device (407), and to peripheral devices such as input/output (I/O) devices (405) through an input/output controller(s) (406).

Typical I/O devices include mice, keyboards, modems, network interfaces, printers, scanners, video cameras and other devices which are well known in the art. In some embodiments, when the data processing system is a server system, some of the I/O devices, such as printer, scanner, mice, and/or keyboards, are optional.

The inter-connect (402) may include one or more buses connected to one another through various bridges, controllers and/or adapters. In one embodiment, the I/O controller (406) includes a USB (Universal Serial Bus) adapter for controlling USB peripherals, and/or an IEEE-1394 bus adapter for controlling IEEE-1394 peripherals.

The memory (408) may include ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, various functions and operations may be described as being performed by or caused by software code to simplify description. However, those skilled in the art will recognize that what is meant by such expressions is that the functions result from execution of the code/instructions by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a tangible machine readable medium includes any apparatus that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented method, comprising:
receiving, at a computer, a request from a host to authenticate a user to sign in an account on the host;
communicating, by the computer, with a mobile phone of the user at a phone number specified by the user to confirm an identity of the user; and
if the identity of the user is confirmed via the communicating with the mobile phone, providing, by the computer, information to the host to allow the user to sign in the account.

2. The method of claim 1, wherein the request comprises a web request from a browser of the user, redirected from the host to the computer.

3. The method of claim 2, further comprising:
providing, by the computer, a user interface on the browser of the user to receive the phone number specified by the user.

4. The method of claim 3, wherein the communicating comprises receiving a personal identification number (PIN) from the mobile phone of the user; and the identity of the user is not confirmed by the computer if the PIN is not associated with the phone number prior to the receiving of the request.

5. The method of claim 4, wherein the providing of the information comprises redirecting the web browser from the computer to the host; and the information comprises an identifier to uniquely represent the user among a plurality of users.

6. The method of claim 5, wherein the identifier is generated from hashing the mobile phone number and the PIN.

7. The method of claim 5, wherein the identifier is pre-associated with the phone number and the host.

8. The method of claim 1, wherein the account is a new account of the user created on the host; and the information associates the account identifier with an identifier representing the user.

9. The method of claim 1, wherein the communicating comprises receiving a one-time password generated on the mobile phone of the user.

10. The method of claim 1, wherein the information is provided by the computer to the host without going through the user.

11. The method of claim 10, wherein the request includes an identification code to identify a session initiated on the host to sign in the user; and the information comprises the identification code.

12. The method of claim 1, wherein the user has a plurality of accounts on the host; and the information provided from the computer to the host allows the user to access the plurality of accounts.

13. The method of claim 1, further comprising:
determining, by the computer, an identifier of the account based on the communicating with the mobile phone, wherein the information comprises the identifier of the account of the user.

14. The method of claim 1, wherein the request comprises the phone number; and the request is received by the computer from the host without going through the user.

15. The method of claim 1, wherein the account is funded by funds associated with the phone number and paid by the computer to the host on behalf of the user.

16. The method of claim 15, further comprising:
transmitting, by the computer, one or more premium messages to the mobile phone to collect the funds.

17. The method of claim 1, wherein the information allows the user to sign in the account, without the user paying the host using the computer.

18. The method of claim 1, wherein the account allows the user to access at least one of: email, instant messaging, social networking, blogging, banking, online shopping, gaming, online communication, and content sharing.

19. A computer-readable storage media storing instructions, the instructions causing a computer to perform a method, the method comprising:
receiving, at the computer, a request from a host to authenticate a user to sign in an account on the host;
communicating, by the computer, with a mobile phone of the user at a phone number specified by the user to confirm an identity of the user; and
if the identity of the user is confirmed via the communicating with the mobile phone, providing, by the computer, information to the host to allow the user to sign in the account.

20. A system, comprising:
a data storage facility to store account information with a mobile phone number of a user; and
an interchange coupled with the data storage facility, the interchange including a common format processor and a plurality of converters to interface with a plurality of controllers, the converters configured to communicate with the controllers in different formats, the converters to communicate with the common format processor in a common format, the common format processor to receive a request from a host to authenticate the user to sign in an account on the host, the common format processor to instruct a first controller of the controllers, via a first converter of the converters, to communicate with a mobile phone of the user at the mobile phone number to confirm an identity of the user, and if the identity of the user is confirmed via communicating with the mobile phone, the common format processor to provide the host with the account information to allow the user to sign in the account.
